(19) United States
(12) Patent Application Publication
(10) Pub. No.: US 2008/0143969 A1
(43) Pub. Date: Jun. 19, 2008

(54) Dynamic superposition system and method for multi-projection display

(76) Inventors: Richard Aufranc, Albany, OR (US); William J. Allen, Corvallis, OR (US); Stan E. Leigh, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/640,041

(22) Filed: Dec. 15, 2006

(51) Int. Cl. G03B 21/26

(52) U.S. Cl. 353/30

(57) ABSTRACT

A system for producing a composite image in a multiple projection system includes at least two projectors, a dynamic image shifting mechanism, associated with at least one of the two projectors, and a controller, connected to control each projector and the image shifting mechanism. Each projector is configured to project a component image to a projection surface at an image refresh rate, and the dynamic image shifting mechanism is configured to shift a projection path of the component image of the at least one projector. The controller is configured to modify image data sent to the at least one projector and to shift the dynamic image shifting device to produce a single composite image comprising the at least two component images.

### BACKGROUND

A composite or tiled display is one in which a single display image is produced using multiple displays or projectors. Such displays are used in a variety of contexts. For example, large display screens at sports stadiums frequently comprise multiple discrete display screens (e.g. LED displays) that are tiled together to produce a single image. In a composite or tiled display, each display screen or projector produces just one discrete portion of the total image. In other applications, multiple projectors are aimed at a common projection surface, with each projector contributing to the complete image.

One challenge presented by composite or tiled displays is that of hiding or blending the edges of adjacent images. This is of particular concern where the composite image is produced by multiple projected images. Composite or tiled display systems often have very obvious borders or transitions between the component images.

Additionally, image and light uniformity is sometimes not consistent across individual display portions in a composite display. Light intensity can vary within each individual portion of the composite display, with the result that the composite image has irregularities in brightness. Moreover, where adjacent image portions overlap in a tiled projection display, the overlapped portion will have multiple projection sources, and can thus tend to be much brighter than the rest of the image. Defective pixels and pixel groups can also be obvious and distracting in a tiled display.

Some approaches to these challenges presented by composite projection systems have attempted static image tiling with edge matching compensation, and manual projector aiming. Unfortunately, these approaches have not completely addressed many of the appearance issues associated with composite displays.

### BRIEF DESCRIPTION OF THE DRAWINGS

Various features and advantages of the invention will be apparent from the detailed description which follows, taken in conjunction with the accompanying drawings, which together illustrate, by way of example, features of the invention, and wherein:

FIG. 1 is a diagram of a composite projection system;

FIG. 2 is an outline of four projected images combined to produce a single composite display, the images being in a first projection position;

FIG. 3 is a diagram of one embodiment of a composite projection system configured to provide dynamic superposition of the image components;

FIG. 4 is an outline of four projected images combined to produce a single composite display, the images having been shifted to a second projection position;

FIG. 5 is an outline of four projected images combined to produce a single composite display, the images having been shifted to a third projection position;

FIG. 6 is an outline of four projected images combined to produce a single composite display, the images having been shifted to a projection position configured to provide a new aspect ratio for the composite image;

FIG. 7 is a flowchart outlining the logic steps involved in one embodiment of the dynamic superposition method for a multi-projection system;

FIG. 8 is a table indicating projection positions during two image frames each having multiple sub-frames, for a four projector composite display system;

FIG. 9 is an illustration of a group of pixels shifted horizontally and vertically by a wobulation system;

FIG. 10 is an illustration of a group of diagonally-oriented pixels shifted vertically by a wobulation system;

FIG. 11 is a diagram of one embodiment of a dynamic superposition composite projection system with wobulation devices associated with each projector; and

FIG. 12 is a table indicating projection positions for a four projector composite display system during two image frames, each frame having multiple superposition sub-frames, and each sub-frame being further subdivided into wobulated sub-frames.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

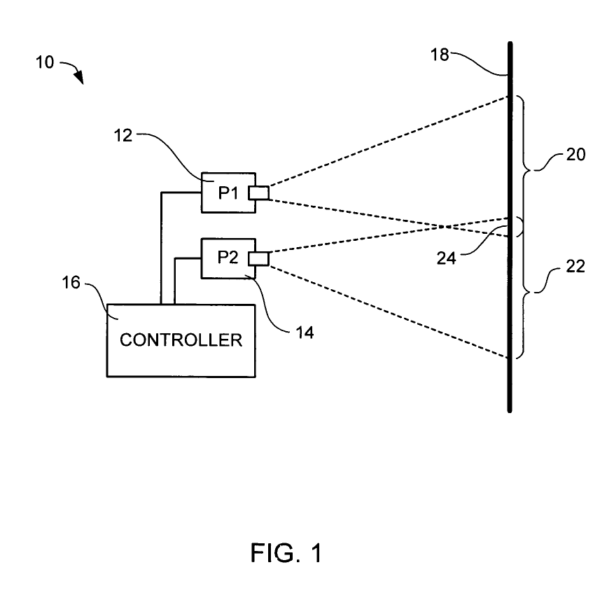

As noted above, a composite or tiled display is one in which a single display image is produced using multiple displays or projectors. A portion of the complete display image that is produced by a given projector is referred to herein as a “component image”, and the total display image is referred to as the “composite image.” An example of a composite display produced by a multi-projection system is illustrated in FIG. 1. The composite display system 10 in this example includes a first projector 12 and a second projector 14, both of which are controlled by a controller 16. The controller divides and manipulates image data and sends this data to each projector so that each of the projectors projects a portion of a composite image to a display surface 18, such as a projection screen or the like. It will be appreciated that in FIG. 1 the display surface is shown in an edge view, and does not show the actual image. While the multi-projector system shown in FIG. 1 includes just two projectors, it will be apparent that multi-projection systems can be configured with any number of projectors.

The first projector 12 produces a first portion (or component image) 20 of the composite image, and the second projector 14 produces a second portion (or component image) 22 of the composite image. As noted above, in composite projection displays, the multiple projection images can have an overlap area 24. In some systems it is intended that this overlap be substantially zero, such that the individual display images merely abut each other. Unfortunately, this approach can produce very obvious borders or transitions between the component images. If the brightness, color saturation, or other parameters of an individual component image (the image from one projector) do not match its neighbors at the edges, an obvious tiling effect will be visible. Additionally, this approach does nothing to compensate for defective pixels or pixel groups in one component image.

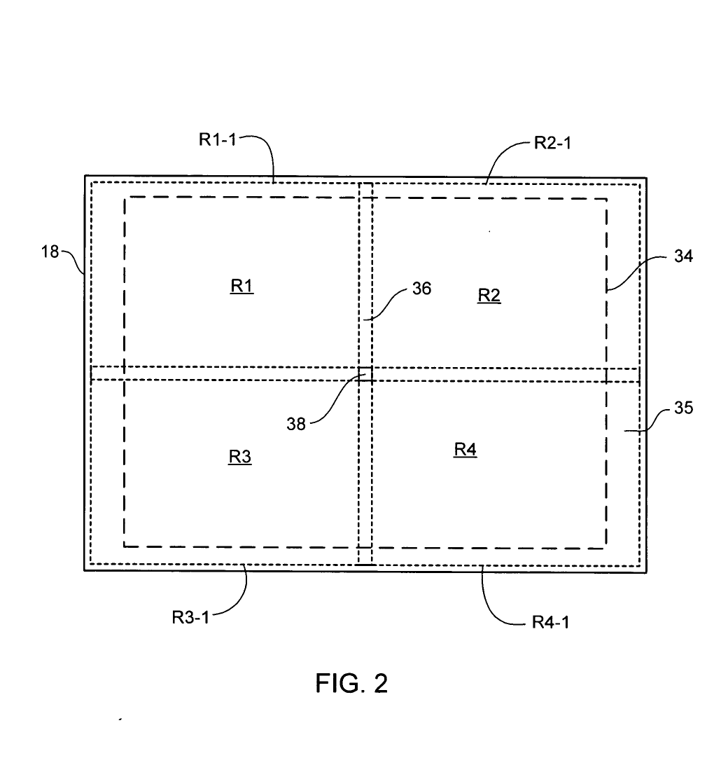

One approach that has been attempted is to provide a permanent image overlap at the image transition locations. Provided in FIG. 2 is an illustration showing the outline of four component images, labeled R1-R4, combined to produce a single composite display image 34 on the display surface 18. These component images are projected in such a way that each component image overlaps the component images adjacent to it, producing an overlap area 36. The controller for the respective projectors (not shown in FIG. 2) can be configured to provide duplicate pixel data to adjacent projectors for projection in the overlap area. The size of the overlap can vary. The permanent overlap area shown in FIG. 2 is not intended to be proportional to the size of overlap commonly used in multi-projection systems, but merely illustrates the concept involved.

While a permanent image overlap like that shown in FIG. 2 can help make the image transitions less noticeable, it is not entirely effective. For example, since the overlap areas comprise common pixel data projected from multiple projectors, the overlap area can be noticeably brighter than non-overlap areas, causing a “grille” effect. This is particularly true for the very center overlap area 38 in FIG. 2, which receives overlap from four different projectors. This “grille” effect can be reduced through edge blending of overlapped images. For example, the brightness of overlapping portions of adjacent component images can be attenuated in the overlap area by restricting the brightness of pixels in the overlap region, with the aim of causing the overall brightness of the overlap area to remain substantially the same as the remainder of the composite image. Other edge blending approaches can also be used. Sometimes, however, edge blending is not entirely effective in eliminating the appearance of this “grille” effect.

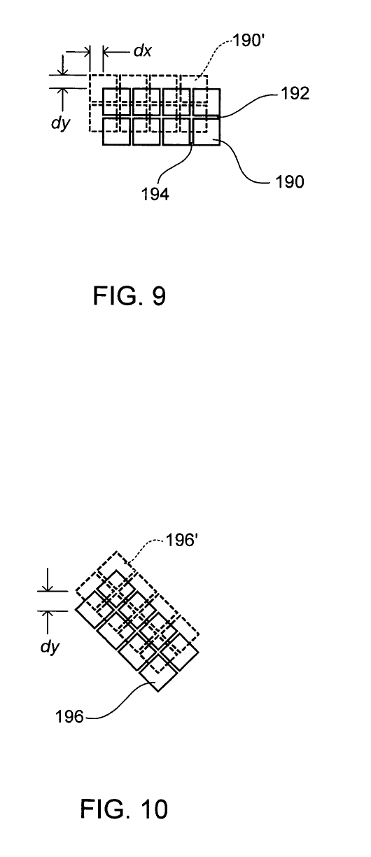

Another issue that affects projected images, whether from a single projection source or in a composite image, is the “screen door” effect. The “screen door” effect is an artifact produced by the optically inactive regions between pixels in an image. These inactive regions can produce vertical and horizontal lines between the pixel blocks. This is illustrated in FIG. 9, which shows a group of pixels 190, having horizontal lines 192 and vertical lines 194 therebetween. When an image is magnified through projection onto a display screen, the lines between pixels can become more apparent, potentially giving the appearance of an image being viewed through a screen mesh, hence the term “screen door” effect.

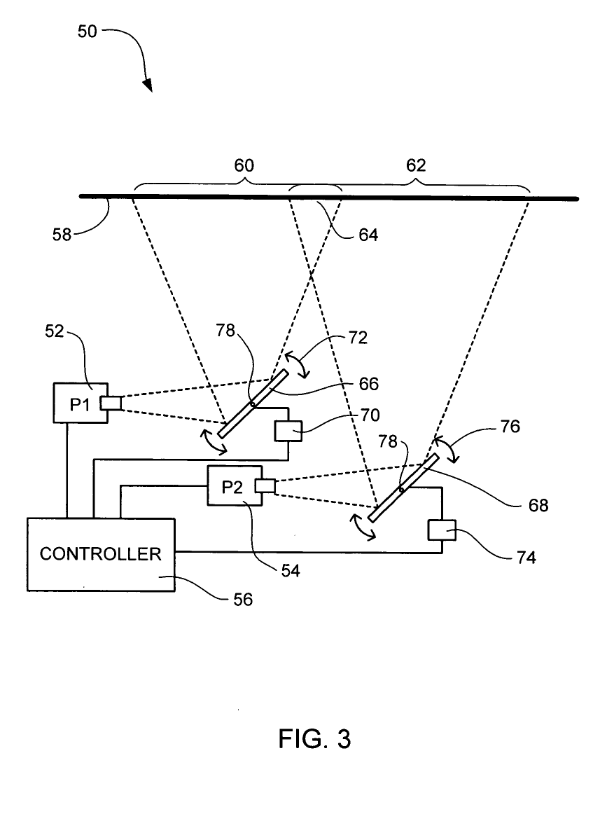

Advantageously, the inventors have developed a system and method that allows the position of component images in a multi-projection system to be dynamically adjusted to help blend image edges and also provide other benefits to the composite image and utility of the projection system. Provided in FIG. 3 is a diagram of one embodiment of a composite projection system 50 configured to provide dynamic superposition of the image components. As with FIG. 1, the display surface 58 is shown in an edge view, and does not show the actual image.

The multi-projection system with dynamic superposition 50 generally includes a first projector 52, designated P1, and a second projector 54, designated P2, both of which are controlled by a controller 56. As with the embodiment of FIG. 1, the controller divides and manipulates image data and sends this data to each projector so that each of the projectors projects a component portion of the desired composite image to the display surface 58. It will be appreciated that a multi-projector system like that shown in FIG. 3 can be configured with any number of projectors, and such systems are not limited to two projectors. The depiction in FIG. 3 includes two projectors for the sake of simplicity.

The first projector 52 (P1) produces a first portion 60 of the composite image, and the second projector 54 (P2) produces a second portion 62 of the composite image. This projection system also includes a tilting mirror associated with each projector. Specifically, a first tilting mirror 66 is associated with the first projector 52, and a second tilting mirror 68 is associated with the second projector 54. The first tilting mirror includes a mirror driver 70 that is coupled to the controller 56 and configured to cause controlled oscillation of the mirror in the direction of arrow 72. Similarly, the second tilting mirror includes a mirror driver 74 coupled to the controller and configured to cause controlled oscillation of the mirror in the direction of arrow 76. The projectors project the respective component images to the tilting mirrors, and the tilting mirrors direct the component images to particular positions on the display surface 58.

The direction and timing of oscillation of the tilting mirrors 66, 68 is controlled by the controller 56 and is temporally coordinated with the provision of pixel data to each projector in order to selectively and dynamically adjust the position of projection of each component image in the composite image. For example, it will be apparent that the position and size of the overlap area 64 between the component images 60 and 62 in FIG. 3 will depend upon the position of the tilting mirrors. As suggested by the arrows 72 and 76, in the view of FIG. 3 the oscillation of the tilting mirrors is about a pivoting axis 78 that passes through the center of the mirror and is perpendicular to the plane of the drawing.

The tilting mirrors 66, 68 are not limited to pivoting only about one axis, however, but can be configured to tilt about two orthogonal axes so that the image projection path can be shifted in two dimensions. During projection of images, such as a moving video image, the controller dynamically recalculates the pixel data to be fed to each projector and simultaneously adjusts the position of the tilting mirrors (in one or two dimensions) so that the image components are precisely placed onto the projection surface and have the desired overlap. The dynamic recalculation and repositioning of images can be performed at a speed that is faster or slower than the standard image refresh rate for the projection systems. Moreover, the speed of repositioning the images need not be constant, but can vary over time, so long as the image shifting is coordinated with the adjustment of pixel data that is fed to each projector.

Several exemplary diagrams of image shifting approaches are provided in FIGS. 2 and 4-6. These diagrams are based upon a projection system having four projectors P1-P4 (not shown), which produce component images that are designated R1-R4, respectively. It should be recognized that the component images in the figures are represented as windows or outlines that delineate an outer boundary for the location of the respective component image. However, the entirety of each component image window is not necessarily occupied by image data at any given time, though it can be. That is, some portions of each component image window may be (indeed, are likely to be) blank at any given time, as described below. Each projected component image can be shifted among multiple projection positions, only some of which are shown in the figures, and which are also designated with numbers. For example, a first position for the component image R1 is labeled R1-1, and a third position for the component image R4 is labeled R4-3, and so forth.

Shown in FIG. 2 is what could be called a first position, with the tilting mirrors (as in FIG. 3) positioned to direct each of the respective component images to their position 1. Thus, the four projected images are labeled R1-1, R2-1, R3-1, and R4-1 in FIG. 2. As discussed above, these tiled images produce an edge overlap 36 (which can be selected to be any desired dimension) and a corresponding center overlap 38.

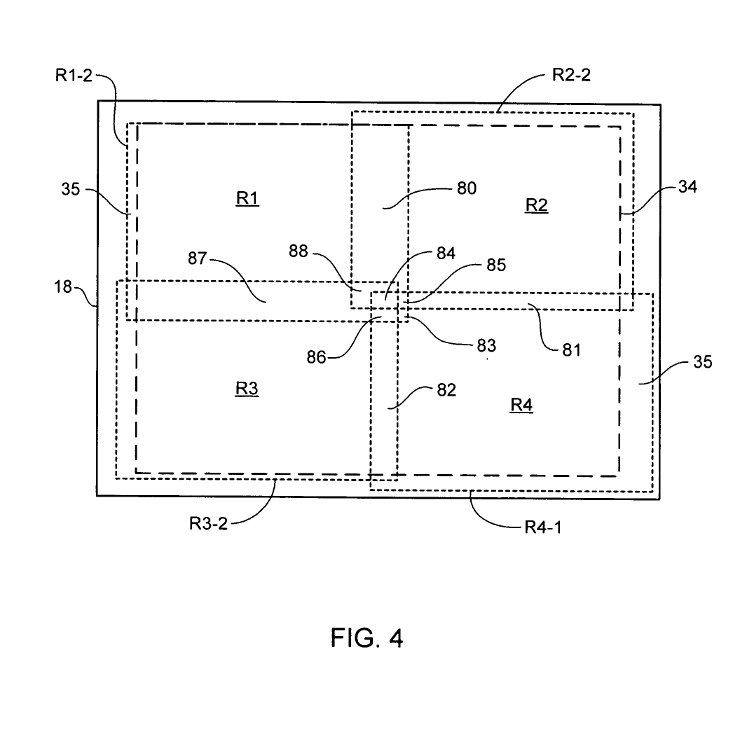

As noted above, however, the configuration shown in FIG. 2 can perpetuate the “grille” appearance, and can also produce bright spots in the image, depending upon the amount of overlap and the quality of edge blending. To address these issues, the positions of the respective images can be varied over time while still creating the desired overall composite image. It will be noted that in FIG. 2 the total composite image 34 has an outer boundary that is inside the outer edges of each component image (R1-1 through R4-1). Consequently, the outer portion 35 of each component image (the portion of the component image window that falls outside the composite image boundary 34) will be blank. The blank portions and overlap portions associated with the composite images provide a range within which the position of each component image can shifted without cutting off or leaving blank any portion of the composite image. In other words, the relative positions of the component image boundaries can be constantly shifting and scanning around the display surface, the image data to each projector being simultaneously dynamically altered to correspondingly shift the image content and position within a given composite image boundary, so that the composite image remains in substantially the same location with respect to the display surface 18. The diagrams of FIGS. 4-6 show several examples of this variation.

In its usual mode of operation, this scanning of component images across a display surface in the manner disclosed herein can be compared to a spotlight shining on a static image on a wall in a darkened room. As an individual spotlight scans across the image, the portion of the image that the spotlight illuminates changes as the spot of light moves, though the position of the total image does not. If multiple spotlights are directed upon the image, the corresponding light spots can overlap with each other, and can extend past the edge of the image. The position of each of the spotlights can vary over time without affecting the appearance of the total image, so long as all portions of the image are illuminated by at least one spotlight. Moreover, the spotlights are interchangeable in that any of the multiple spotlights can be used to illuminate any portion of the image surface (subject to any limitations of the spotlight steering system).

The component images in the dynamic superposition system are similar to the spotlights in the above analogy. The position of a given component image can change over time without affecting the position of the composite image so long as the image data to each projector is modified accordingly, and so long as all regions of the composite image are provided (i.e. covered) by at least one component image. When the position of a given component image shifts to the upper right, for example, the image data that is sent to the corresponding projector can be shifted to the lower left of that component image window, so that the composite image remains in the same position relative to the display surface. Also like the spotlights, any of the component images can be directed to any portion of the display surface. The variations shown in FIGS. 2 and 4-6 are not intended to suggest that any particular component image is necessarily restricted to a particular portion of the composite image area (e.g. component image R1 is not restricted to the upper left quadrant of the composite image). Unlike spotlights, however, the portion of any component image window that falls outside the boundary of the composite image will be dark.

The shifting of the position of the component images while keeping the position of the composite image constant is noted above to be the usual mode of operation. However, it will also be apparent that the position of the composite image can also be changed, either by reapportioning the data to the respective projectors, or by providing a common shift of all of the tilting mirrors. Shifting the position of the composite image may be undesirable in many instances, but may be desirable in others.

Provided in FIG. 4 is an outline of the four component images R1-R4 combined to produce the composite image, but with three of the four component images shifted from the position shown in FIG. 2. In this view, images R1-R3 have been shifted to different projection positions, designated position 2 (thus R1-2, R2-2, R3-2), while the fourth image R4 remains at position 1 (R4-1) as it was in FIG. 2. Nevertheless, the composite image 34 still retains the same dimensional boundary and is in the same location with respect to the display surface 18.

Because of the change in position of the component images with respect to the boundaries of the composite image, the relative proportion of blank space 35 in each of the component images also changes. For example, the top edge of component image R1 in FIG. 4 is coincident with the top boundary of the composite image. However, there is a small region of blank space 35 on the left side where image R1 extends past the boundary of the composite image. On the other hand, since image R4 is still in its position 1, the blank space 35 on the bottom and right sides of this component image is still relatively large. It will be apparent that, depending upon the size shape and location of the composite image relative to the display surface 18, the range of spatial variation of one or more of the component images could extend past the boundaries of the display surface. Since any portion of the component image that falls outside the boundaries of the composite image will be blank or non-illuminated, there will be no portion of the composite image that falls off of the display surface (unless, of course, the boundaries of the composite image also extend outside the boundary of the display surface).

The edge overlap between the various adjacent component images also changes as the component images shift position. This is apparent by comparing FIGS. 2 and 4. Whereas in FIG. 2 the symmetrical arrangement of the component images produced four edge overlap areas 36 where only two adjacent images overlapped, and one center overlap area 38 where all four component images overlapped, the configuration of FIG. 4 provides a more complicated overlap situation. In this configuration there are a variety of overlap areas between two, three and four different adjacent component images. Specifically, component image R1 overlaps with component image R2 in area 80, R1 overlaps with R3 in area 87, R2 and R4 overlap in area 81, and R3 overlaps with R4 in area 82. Additionally, R4 and R1 overlap in area 83, all four images overlap in area 84, R1, R2 and R4 overlap in area 85, R1, R3 and R4 overlap in area 86, and R1 and R3 overlap in area 88. In addition to dynamically recalculating the image data that is provided to each projector in the system, the system controller can also dynamically recalculate the edge blending required for each component image in each overlap area in order to produce a desired composite image of substantially uniform brightness.

This variation of shifting of the component images has several effects. First, since the size and position of overlap are not static, the overlap areas become less noticeable. Temporal shifting of the overlap areas helps hide defects in edge blending between adjacent images, and thereby reduces the “grille” effect because the position and extent of overlap that creates the “grille” appearance will vary over time.

Second, this has the effect of reducing the “screen door” effect because the boundaries between adjacent pixels are effectively diffused while the image position remains stable. The shifting of the component images need not be in pixel size increments. That is, the distance from one position of a component image to its next subsequent position does not have to be a multiple of the dimension of the pixels in the image. The dynamic superposition system can recalculate or resample the image data, and produce a new pixel arrangement that is offset a partial pixel (or multiple of a partial pixel) dimension from the previous position, but still produces the same image. Consequently, the location of the lines between pixels can continuously change, thus eliminating the “screen door” appearance (in a manner similar to that associated with wobulation, discussed below). This effect can be compared to viewing a painting while holding a piece of screen mesh in front of it. So long as the screen remains static, its presence is obvious. However if the screen is rapidly moved about in a plane parallel to that of the painting, the screen can seem to disappear, improving the appearance of the painting below.

Another effect of the dynamic superposition system is that it can increase uniformity in the composite display. This includes uniformity in both color and brightness. It will be apparent that multiple projectors of identical design and construction can nevertheless present differences in their respective displayed images. For example, the lamps in one projector can provide a more bluish light, while that of another is slightly more yellow. The brightness and color of the lamps can also vary due to age, manufacturing irregularities, and other factors. Consequently, there can be noticeable color and brightness differences between adjacent component images in a composite image. The dynamic superposition system helps reduce the appearance of these differences by shifting the positions of the component images over time, so that the color and brightness of the respective images are mixed together. The shifting of component images thus evens out the color and brightness differences of the multiple projectors, and also smooths out the transition between overlap regions and regions where only one of the projectors provides a portion of the composite image. Non-uniformities (e.g., variations in brightness and/or color hue) within a single component image are also mitigated by diffusing them by shifting the position of the component image.

Additionally, the dynamic superposition system helps hide defective pixels. A defective pixel in a given proiector can produce a black spot (if a pixel is stuck in the off condition) or a white spot (if the pixel is stuck on) in the image produced by that projector. Where the position of the projected image is static, the defective pixel will remain in a constant location and be readily apparent. However, the dynamic superposition system disclosed herein can help hide defective pixels in at least two ways. First, since the overlap areas between adjacent component images receive common pixel data from multiple projectors, good pixel data from one projector can help cover a defective pixel from another projector. Second, with individual component images shifting position over time, the location of the defective pixel with respect to the display surface will also change. Depending upon the frequency and pattern of shifting, this can help hide the defective pixel by effectively blurring it, even in a region of a composite image that is produced by only one projector. Those skilled in the art will be familiar with various methods for hiding defective pixels in a projected image.

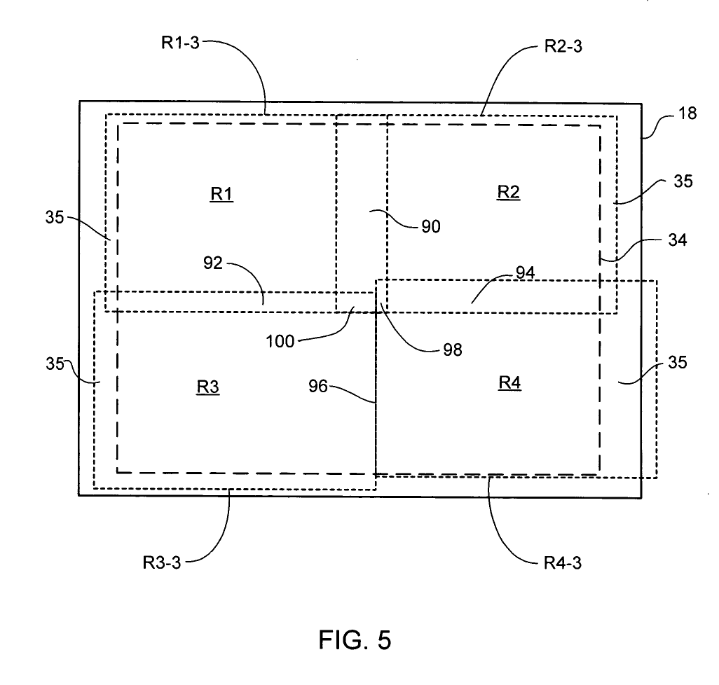

Another diagram of a shifted image arrangement is shown in FIG. 5. In this arrangement, the image from projector 1 is shifted to position R1-3, the image from projector 2 is shifted to position R2-3, the image from projector 3 is shifted to position R3-3, and the image from projector 4 is shifted to position R4-3. As with FIGS. 2 and 4, the location of the composite image remains the same with respect to the display surface 18, but the blank area 35 associated with each component image changes. Likewise, the overlap areas also change in size and position. There is an edge overlap area 90 between image R1 and image R2, and a different sized edge overlap area 92 between image R1 and image R3. The edge overlap 94 between images R2 and R4 has also changed, and the overlap between images R3 and R4 has diminished essentially to zero, such that these component images merely abut each other. At the same time, the position and composition of the center overlap has also changed. Images R1, R2 and R4 overlap in center area 98, while images R1, R2 and R3 overlap in center area 100. There is no location in this composite image where all four projected component images overlap. It will also be apparent that component image R4 in FIG. 5 extends beyond the edge of the display surface. However, as noted above, since the portion of R4 that falls off the edge of the display surface is blank, there is no apparent change in the composite image and the area beyond the edge of the display surface is not objectionably-illuminated.

The diagrams of FIGS. 2 and 4-5 show three of many possible image position combinations through which the system can shift over time. For example, at some initial time To the system can be configured to project all component images to the positions shown in FIG. 2. Then at time T₁ the system can shift to project the images to the positions shown in FIG. 4, and at time T₂ the system can shift the images to the positions shown in FIG. 5. The system can then shift to other combinations that are not shown, and/or repeat this sequence, or enter into a different shifting sequence. It will be apparent that where there are four component images and each image can be shifted between one of four positions, there will be sixteen possible image position combinations. It will be appreciated, however, that a four position range is only suggested for illustrative purposes. The number of possible projection positions for each projector can be much greater than four (indeed it can be nearly infinite), and thus the number of possible projection combinations is also much higher.

The way in which the system proceeds through the various projection position sets can also vary. For example, the system can be designed to pass through a short or long sequence of shifting position sets in a particular order, or it can proceed through a large group of possible image shifting combinations in random order. Other sequences are also possible.

The time duration of each image position combination can also vary. For example, the component image positions can move continuously (e.g. sinusoidal displacement) or snap and dwell at fixed locations. The time segments T₀, T₁ and T₂ can be any length, from a fraction of an image frame period to any longer length. The time intervals need not be the same length, either. To can be longer than T₁, and T₂ can be longer than T₀, for example. It will also be apparent that the number of time segments in any shifting sequence can vary, and the duration of the shifting sequence can also vary. Where more time segments are squeezed into a fixed length time interval, the average length of those time segments will shrink and the shifting speed will be correspondingly faster. On the other hand, having more time segments can make the total shifting sequence longer, without necessarily increasing the shifting speed. It will be apparent that the maximum possible shifting speed can be determined by mechanical factors, such as the maximum speed at which the shifting mirrors can physically move, or by electrical or data constraints, such as the maximum rate at which the system can process and display the intermediate sub-frames (or image frames).

If the motion scheme of shifting is sinusoidal (versus snap and dwell), there can be some smearing of component images. Smearing occurs when a component image is shifted in position without a corresponding change in image data. Smearing can affect the overall image quality, and can be optimized as an engineering tradeoff against the cost of reducing smearing. For example, a small amount of smearing can be considered desirable to help blur and hide pixel boundaries, thereby smoothing out the appearance of an image and giving better image quality.

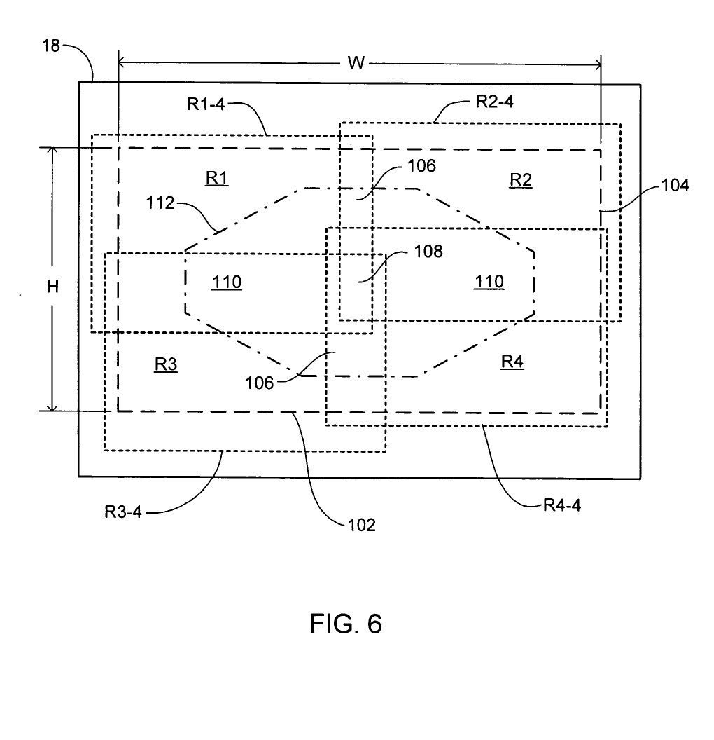

A dynamic superposition system as disclosed herein can also be used to adjust the shape of the composite image. This feature can be used to change the aspect ratio of the composite image, for example. The composite image 34 shown in FIGS. 2 and 4-5 has an aspect ratio of approximately 4:3 (width to height), corresponding to a traditional television picture shape. However, the dynamic superposition system can allow the aspect ratio of the composite image to be changed. Provided in FIG. 6 is an outline of four projected images R1-R4 combined to produce a single composite image with a different aspect ratio from that shown in FIGS. 2 and 4-5. In this configuration, the image data is modified to produce a composite image with a different aspect ratio, and the images from each of four projectors are shifted to a fourth position that combines them to produce the new aspect ratio. Specifically, the image from projector 1 is at position R1-4, that from projector 2 is at R2-4, and so forth. The image data to each projector is manipulated to change the location and shape of the image within each component image window, so that the combination of the component images produces the composite image with a different shape. In the arrangement of FIG. 6, the result of this shift produces a composite image 102 having a new height H and width W that are different from those of the composite image 34 shown in previous figures. In the configuration of FIG. 6 the composite image 102 has a 16:9 aspect ratio, which is a standard form for broadcast high definition television. However, it will be apparent that adjusting the aspect ratio in this way can provide any desired aspect ratio, including non-standard ratios.

Manipulation of the shape of the composite image in this way can also be performed to provide any other image shape, and is not limited to adjustment of the aspect ratio. It will be apparent that a composite image of any shape can be created using the dynamic superposition system. For example, as shown in FIG. 6, the composite image can be cropped to have an elongated octagonal shape, represented by outline 112. Other shapes, such as hexagonal, elliptical, stripes, spirals, etc. can also be created. A different shape for the composite image basically modifies the spatial range within which the component images can be shifted and still collectively cover the entirety of the composite image area.

Taking the dynamic superposition concept one step further, it will be apparent that a total overlap condition can be created. That is, all projectors in a multi-projection system can be shifted to project to a common position, so that all projectors have a substantially 100% overlap with all other projectors. As a practical matter, it can be difficult to cause multiple projected images to align perfectly, but projected images can be arranged so that the composite image is just slightly smaller than any of the component images, and good alignment can be obtained. It will be apparent that this condition can provide very good image brightness, though at the expense of the size of the composite image (relative to the size of the component images).

As the size of the composite image shrinks and approaches the size of any of the component images, the possible spatial range for shifting of individual component images will increase, as will the possible amount of overlap between component images. This can enhance some of the image quality effects that the dynamic superposition system provides. For example, where there is more overlap of the component images, there is greater capacity for covering up defects that might exist in any one of the component images. More overlap can also increase the ability of the system to blend colors and provide more uniform brightness. To go a step further, where the composite image is of a smaller size than any of the component images, the component images can completely overlap while also dynamically shifting position at the same time.

On the other hand, less overlap will reduce image redundancy that can hide defective pixels. At the same time, a lesser overlap situation can be used to help increase resolution by providing a greater number of pixel addresses within the composite image area. For example, if each projector in a multi-projector system provides a component image that is 200×100 pixels, a full overlap condition with perfect alignment will address 200×100, or 20,000 pixels in the composite image. However, if the projectors are tiled with butted edges, each projector will address 200×100 pixels, so that the entire composite image will have 400×200 or 80,000 individually addressed pixels. If at that point all projectors are zoomed down (e.g. using projection optics) so that the tiled composite image occupies the same area on the display surface as the original 200×100 image, this will provide 80,000 pixels in the area that originally had 20,000 pixels. In this way holding the composite image size constant can provide higher resolution.

A condition between the complete overlap situation and the zoomed-down-no-overlap situation can also be used. For example, beginning with a full perfect overlap condition, the positions of the component images can then be disturbed slightly, e.g. ½ pixel, with correspondingly changed data sent to each projector. This approach delivers image information at a higher spatial frequency than the perfectly overlapped 200×100 system, and thus provides more resolution than the perfect overlap situation, but provides less resolution than the 400×200 zoomed down system.

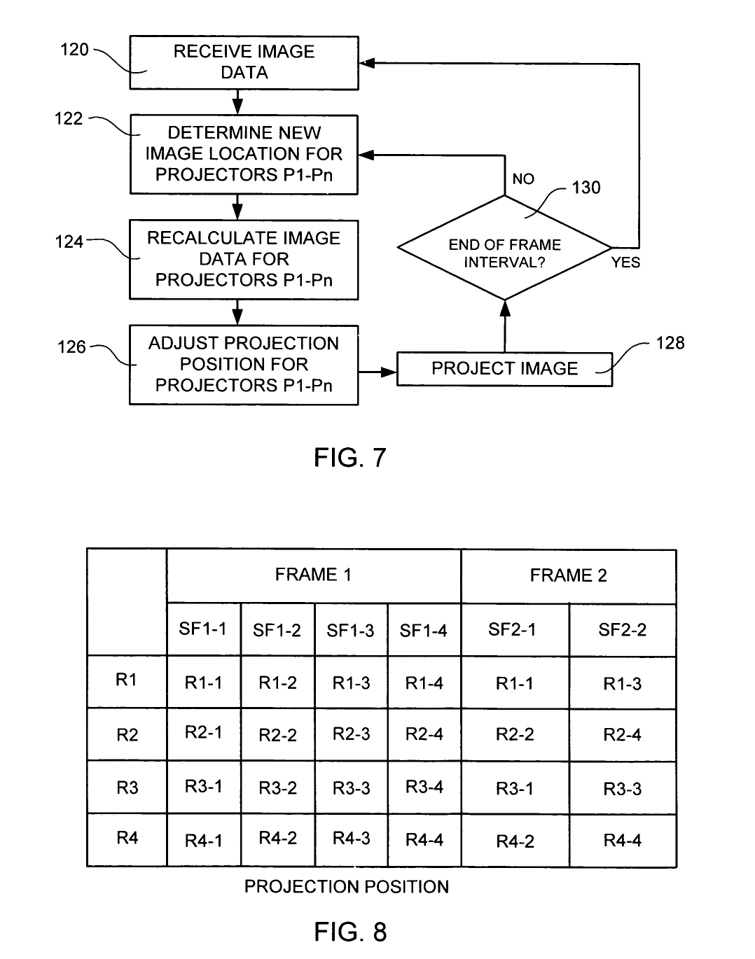

Provided in FIG. 7 is a flowchart outlining the logic steps involved in an embodiment of a dynamic superposition system having n projectors (numbered P1-Pn). The process begins with the projection system receiving image data (i.e. pixel data) for an image to be projected (step 120). In most cases this data will be image data corresponding to one image frame, but it could also be data for multiple frames. As suggested above, the system can be programmed with an image shifting sequence, which determines the projection positions for each projector for each successive image or frame. Alternatively, an image shift command can be included with the image data. Such an image shift command can comprise a bit string at the beginning of each image frame data string, and indicates to the superposition system how the particular frame (or a group of frames) is/are to be shifted. This approach can allow a given video sequence to provide shifting commands that are specifically tailored to the nature or characteristics of the video. For example, the shifting commands can be configured to take maximum advantage of benefits to brightness or color saturation depending upon the brightness or colors in a given image or image sequence. As another example, the image shift command string can cause adjustment of the aspect ratio of the composite image.

Whether based upon a preprogrammed image shifting sequence or image shift commands transmitted with the image data, the system next determines or reads the new projection locations for each projector (step 122). This step essentially involves determining the intended physical position for each tilting mirror (66, 68 in FIG. 3) to provide the intended component image position on the display surface. Based upon the intended component image locations, the system can then recalculate the image data for each projector (step 124) in order to provide the proper data in view of the overlap and component image position. That is, the image data for the entire composite image is divided for transmission to the respective projectors in a way that ensures that all overlap regions will include common image data. The system then sends corresponding signals to the tilting mirrors to adjust the projection positions (step 126) and projects the image (step 128).

While the flow chart of FIG. 7 depicts one approach to control of a dynamic superposition system, other approaches are possible. For example, rather than modifying the data (step 124) and then adjusting the tiltling mirrors accordingly (step 126), the reverse can take place. That is, the image position (or mirror position) can be set first (step 126), and the image data can then be manipulated accordingly (step 124). Indeed, most required image data manipulation can be precalculated, or it can be done “on-the-fly.”

Once the image has been projected, the next step can depend upon whether the image shifting sequence applies to a full image frame or more, or whether the image shifting sequence applies to less than a full image frame interval (step 130). If the projection of the image with shifted component images represents the end of a single image frame interval, the system returns to step 120 to receive image data for the next image frame and then repeat the process. However, if the image shifting sequence corresponds to less than a full frame (i.e. there are multiple shift positions for a single image frame), the system returns to step 122 to repeat the process to determine and set the next shift combination using the same image data.

The respective projection positions per image frame for each projector in a four projector image shifting system are outlined in the table of FIG. 8. The left column indicates the component images, labeled R1-R4. The first image frame, labeled Frame 1, is temporally divided into four image sub-frames, labeled SF1-1 to SF1-4. The second image frame, labeled Frame 2, is temporally divided into two image sub-frames, labeled SF2-1 to SF2-2. An image sub-frame is a temporal subdivision of an image frame time interval. In a video system having a standard refresh rate of 60 frames per second, the time interval of each frame will be approximately 1/60 second. Consequently, each sub-frame of FRAME 1 can be one fourth of that, or 1/240 second. On the other hand, each image sub-frame of FRAME 2 can be half of the total frame interval, or 1/120 second.

In the exemplary sequence depicted in FIG. 8, during frame 1, each component image is directed in sequence through each of four discrete projection positions. That is, during SF1-1 all component images are at their position 1 (labeled R1-1, R2-1, R3-1 and R4-1), during SF1-2 all component images are at their position 2 (labeled R1-2, R2-2, R3-2 and R4-2), and so forth. However, during the second frame, the image projection sequence varies. During SF2-1, component images R1 and R3 are directed to their position 1 (R1-1 and R3-1), while component images R2 and R4 are directed to their position 2 (R2-2 and R4-2). Similarly, during SF2-2, component images R1 and R3 are directed to their position 3 (R1-3 and R3-3), while component images R2 and R4 are directed to their position 4 (R2-4 and R4-4).

It will be apparent that the projection positions and the sequence of position shifting shown in FIG. 8 are examples only, and are highly simplified for purposes of explanation. Many more combinations and variations are possible. For example, each projector can be configured to shift between many positions, and is not limited to four positions. Additionally, the order of shifting can vary, such as according to a random selection algorithm, or in response to individual shifting command strings provided with image data groups.

The movement of component images can be in discrete jumps as illustrated above, or the system can be configured to provide smooth transitions throughout a range of projection positions. The movement frequency can be at a very high sub-frame timing (e.g.many temporal sub-frames and corresponding image position shifts per each image frame), or as slow as many frames per cycle (e.g. an image shift after some number of complete image frame intervals). Where sub-frame timing is used, the length of the sub-frames can vary and does not need to be uniform. For example, where a 1/60 second image frame is divided into two sub-frames, the first sub-frame can be 1/100 second, while the second sub-frame is 1/150 second.

A dynamic superposition system and method as disclosed herein can also provide many of the benefits of or be combined with a wobulation system. A wobulation system is a system that shifts the pixels in an image a fraction (typically) of a pixel dimension at a rate that can be a multiple of the image refresh rate, while simultaneously resampling the image data to compensate for the new pixel position while retaining the projected image in the same location relative to the projection surface. The result of wobulation is to obscure pixel edges and increase the number of addressed locations in the displayed image, and thus increase the apparent resolution of the image.

The image-shifting effect of a wobulation system upon a projected image is illustrated in FIGS. 9 and 10. Shown in FIG. 9 is a group of horizontally-oriented pixels to illustrate the effect of shifting the image as described above. The group of pixels 190, shown in solid lines, represent a portion of an image when at a default projection location. This can be the pixel location when the wobulator window is at a neutral position. However, when the wobulator window tilts in one or more degrees of freedom, the position of the group of pixels is shifted to a shifted position, represented by the pixel group 190′ (in dashed lines). The shifted pixel group shown in FIG. 9 is shifted upward a distance dy, and to the left a distance dx from the default pixel location. This sort of shift can be produced by two-axis wobulation, or it can be provided by a single-axis wobulator device that is oriented with its pivoting axis oriented at some angle (e.g. 45°) with respect to the alignment of rows and columns of pixels. In other words, the shift is parallel to the diagonal across an individual pixel.

An alternative wobulation scheme is illustrated in FIG. 10, wherein a group of pixels 196 is oriented in a diagonal orientation, rotated approximately 45° from the horizontal. In this configuration, the shifted pixel group 196′ is effectively shifted parallel to the diagonal across individual pixels using a vertical shift dy.

Wobulation devices are sometimes configured to provide a shift that is less than the maximum dimension of a pixel. When thus shifted, additional locations in the displayed image are addressed. In addition, the screen door effect is diffused because the projected image is shown in multiple positions. Because the screen door artifact appears in multiple positions, its visibility is thus diffused. Even if the projected image is moved smoothly (as opposed to snap and dwell) the screen door effect will be mitigated. This reduces the visibility of individual pixels in the displayed image. With snap and dwell to fractional pixel positions, a wobulation system addresses more locations in the displayed image (with proper sub-frame data) than a system that doesn't shift and change projected image data. The term “address” with respect to a pixel refers to the location of the center of the pixel. If the position of the pixel changes, the location of its center changes. Where pixels are shifted by a distance that is a fraction of the size of one pixel, the center of each pixel will move to a position that was not occupied by any pixel center immediately prior to that shift. With this type of wobulation shift there is some smoothing (blurring) from the shifting and overlapping pixels, but there are more addressed locations in the projected image, which can provide an increase in spatial resolution (i.e. deliver information at a spatial frequency higher than in a non-wobulated control system) in the final image. The wobulated images thus have more apparent resolution and less visible pixel structure.

Wobulation can be used to increase the apparent resolution of a static image, or of a video image that is made up of a temporal series of images or frames, each frame being projected for an image frame period. Each wobulated or shifted image position can correspond to one temporal subdivision or sub-frame of the image frame period.

While the magnitude of shifting provided by a wobulation device is typically very small (i.e. less than the dimension of a single pixel), the magnitude of shifting provided by the dynamic superposition system described herein can be very large, as is apparent from the examples described above with reference to FIGS. 2 and 4-6.

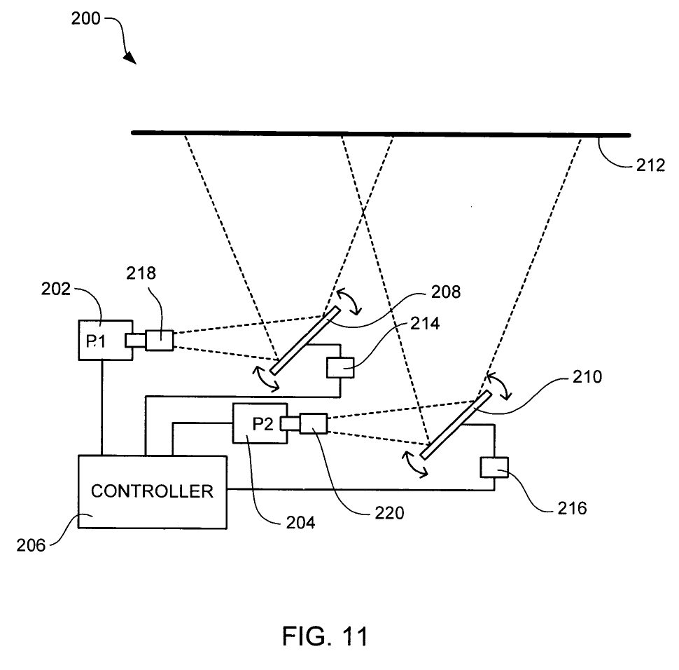

A multi-projector dynamic superposition system as disclosed herein can be configured to provide the benefits of a wobulation system, along with the benefits of dynamic superposition. This can be done in several ways. One way is illustrated in FIG. 11, which depicts a multi-projector system 200 that is similar in most respects to that shown in FIG. 3. This system includes a first projector 202 (labeled P1) and a second projector 204 (labeled P2) that are each interconnected to a common controller 206. Associated with each projector are tilting mirrors 208, 210, which direct the images from each projector to a common projection surface 212. The tilting mirrors have drivers 214, 216 which are interconnected to the controller, and cause the tilting mirrors to shift (in one or more degrees of freedom) the direction of the component images to provide the dynamic superposition effect.

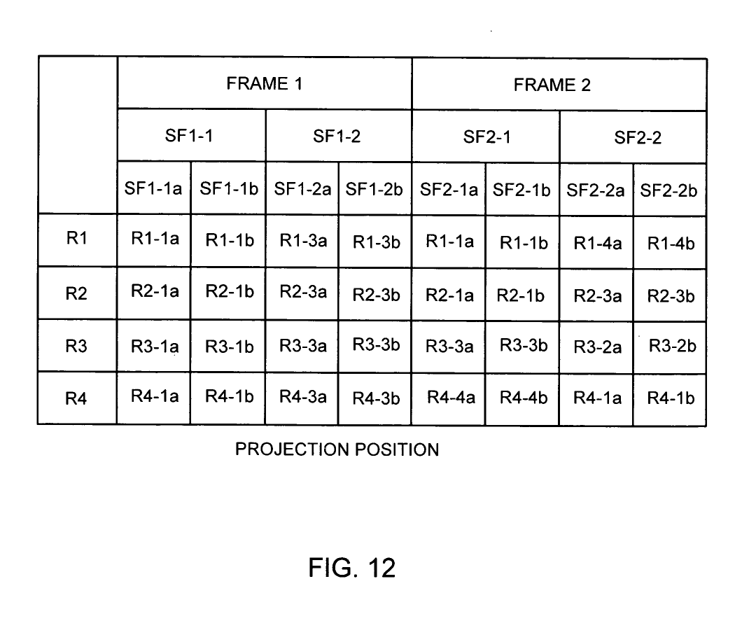

Unlike the system of FIG. 3, each projector in FIG. 11 is also provided with a wobulation device. The first projector 202 has a first wobulation device 218, and the second projector 204 has a second wobulation device 220. These wobulation devices provide sub-pixel shifting of the respective component images before the typically larger-scale shifting is provided by the respective tilting mirrors 208, 210. The operation of the wobulation devices can be controlled by the controller 206, so that the wobulation is temporally and spatially coordinated with the dynamic superposition shifting. As noted above, wobulation typically occurs on a small spatial scale, and possibly also at a higher frequency than dynamic superposition shifting. Alternatively, the wobulation device associated with each projector can be controlled by the individual projector itself (or a controller associated with it), while the dynamic superposition system can provide a separate single controller for all projectors. Various combinations of wobulation shifting and dynamic superposition shifting and their temporal occurrence are discussed below with respect to FIG. 12.

As an alternative to providing each projector with a separate wobulation device, a dynamic superposition system as illustrated in FIG. 3 can be configured to simultaneously provide image shifts on a macroscopic scale and on a wobulation scale without the introduction of separate wobulation devices. That is, a dynamic superposition system as disclosed herein can be configured to reduce the screen door effect and address other issues associated with composite displays by shifting the projected images relatively large distances, like those illustrated in FIGS. 2 and 4-6, and can at the same time make very small wobulation scale shifts in image positions, shifts that are comparable in magnitude to those used in wobulation systems. The terms “macroscopic scale” and “large distance” in this context mean a distance larger than the dimension of a single pixel. The term “wobulation scale,” on the other hand, refers to a distance that is smaller than the dimension of a single pixel. Thus the system can shift individual images by a wobulation or sub-pixel distance to obtain the wobulation effect, while also shifting by larger distances to obtain the benefits of dynamic superposition. For example, the system can shift an image by a distance of 5 and ½ pixels between sub-frame display positions, adding a macro shift of 5 pixels with a mirco shift of ½ pixel. The two shifts can be added so that one step is made (i.e. one shift of the tilting mirrors) instead of two independent shifts. In other words, the dynamic superposition system can provide long (i.e. multi-pixel) shifts with fractional pixel precision. Additionally, the system can produce the dynamic superposition effect by shifting a given component image through a succession of wobulation scale shifts (i.e. fractional pixel distances) one after the other. That is, the boundaries of a component image can travel a large distance across the projection surface with a precision on the scale of very small individual steps.

Depending upon the relative rate of image shifting on the macroscopic scale, the simultaneous shifting on both the macroscopic and wobulation scales can involve the division of individual image frames into sub-frames on two levels. This sort of approach is depicted in FIG. 12, which provides a table indicating one example of projection positions for a four projector composite display system configured for both dynamic superposition and wobulation functions through two hypothetical image frames. As shown in this table, each image frame is divided into two superposition sub-frames, labeled SF1-1 and SF1-2 for FRAME 1, and SF2-1 and SF2-2 for FRAME 2. Each superposition sub-frame is further subdivided into two wobulated sub-frames, labeled SF1-1a and SF1-1b for sub-frame SF1-1, and so on.

As with the system considered with respect to the table of FIG. 8, the system associated with FIG. 12 is presumed to include four projectors, each having tilting mirrors and associated hardware and programming to shift the projected images on a macroscopic level between at least four positions, which are numbered 1 to 4. At the same time, the tilting mirrors (or a separate wobulation system associated with each projector) can also be configured to shift on a wobulation scale between at least two wobulation positions, which are labeled a and b. Thus, when displaying wobulated sub-frame SF1-1a, the dynamic superposition system directs each component image to its position 1a, and when displaying wobulated sub-frame SF1-1b the component image is directed to its position 1b.

This can be done in more than one way. In one embodiment, the tilting mirrors (208 and 210 in FIG. 11) can direct their respective component images to a position that is between positions 1a and 1b for the respective projector, and then the wobulation devices (218 and 220 in FIG. 11) can make a fine position adjustment so as to place the component image at 1a and then at 1b. Alternatively, the two shifting elements (tilting mirrors and wobulation devices) can cooperate to ultimately place the component image in the correct place on the display surface. Other schemes can also be used. During display of wobulated sub-frame SF1-2a, the dynamic superposition system directs the component image to its position 3a, and during display of wobulated sub-frame SF1-2b the component image is directed to its position 3b.

In the wobulated sub-frames, the shifting between positions a and b represents a wobulation scale shift, like that shown in FIG. 10. This type of shift (whether in one dimension or two) helps increase the apparent resolution of an individual projected component image. The shifting between positions 1 and 3, on the other hand, can be on a larger scale, and can be a shift associated with the overall dynamic superposition system to help improve the appearance of the composite image by blending the component images better, and can have (and is more likely to have) a magnitude greater than the dimension of a single pixel.

Frame 2 has a different and more complex positioning sequence. During display of wobulated sub-frame SF2-1a, the dynamic superposition system directs component image R1 to position R1-1a, component image R2 to position R2-2a, component image R3 to position R3-3a, and component image R4 to position R4-4a. Then, in SF2-1b component images R1-4 project to positions 1b-4b, respectively. Sub-frame SF2-2 essentially reverses the order. In SF2-2a, component image R1 is directed to position R1-4a, component image R2 is directed to R2-3a, component image R3 to position R3-2a, and component image R4 to position R4-1a. In SF2-2b the tilting mirrors each shift to the respective wobulation position b. Thus component image R1 is directed to position R1-4b, component image R2 is directed to R2-3b, R3 to position R3-2b, and R4 to position R4-1b.

While only a few projection shifting combinations are shown in FIG. 12, it will be apparent that the macroscopic shifting and wobulation scale shifting can be carried out in a wide variety of combinations. Additionally, since wobulation scale shifting represents essentially the same process as macroscopic shifting, only on a smaller scale, the macroscopic shifting result can be obtained by rapidly shifting through a large number of substantially consecutive wobulation scale shifts. With regard to the frequency of shifting, it should be recognized that while the dynamic superposition shifting can be done on a multi-frame basis (i.e. shifting at a rate that is slower than the image refresh rate), wobulation is done on a per frame or sub-frame basis (i.e. shifting at a rate that is equal to or greater than the image refresh rate).

It should be recognized that the dynamic superposition image shifting generally does not change the position of the composite image, but only changes the portion of the total image that is provided by a given projector. At the same time, it should be recognized that wobulation does change the actual position of the projected image typically by a fraction of the size of a pixel, though the image information is changed in synch with the position of the projected image, as discussed above. Since wobulation occurs at a greater than frame-rate frequency, the viewer perceives the image as having higher resolution. The dynamic superposition system can thus be thought of as a sort of macro wobulation system, though it is distinct in that it uses multiple projectors and can more significantly change overlap regions.

The system can also be configured to dynamically adjust the amount of overlap, and thereby more carefully control the image brightness, by blocking out an overlap portion of the image projected from a given projector, rather than edge-blending overlapping images. For example, viewing FIG. 2, while the edge overlap areas 36 receive a common image projection from two projectors, the center overlap area 38 will presumably receive the corresponding projected image from all (in this case, four) projectors in the system. This can make edge blending in the center area more difficult, potentially causing the center area to have noticeably different brightness than the rest of the composite image.

To prevent this, in the process of dynamically recalculating pixel data to be transmitted to each projector, the system can be configured to block out multiple overlap areas from selected projectors to reduce the excessive overlap. For example, the system can be configured to ensure that all overlap areas receive common image projection from only two projectors. In the case of FIG. 2, this can mean that the image for the center region 38 will be an overlap of images R1 and R4, but not R2 or R3. In such a situation, the images R2 and R3, if viewed separately from the composite image, would each have a small blank (i.e. black or dark) region in the corner corresponding to the position of region 38 in the composite image. This effect can also be accomplished over time with or without edge blending brightness between images.

The dynamic superposition system disclosed herein provides a system and method for independently moving each image component of a multiple projection system in a composite display. Each projector can be provided with a steering mirror that can tilt rapidly (i.e. at a frequency less than, equal to or higher than the standard image refresh rate) to redirect the projection path of the image. The overlapping portions of adjacent images are provided with common pixel data, and the input to each projector is simultaneously recalculated, based on relative position, so as to provide better blending of image edges, provide more uniform luminance, and/or provide a different aspect ratio for the composite image.

The dynamic superposition system thus helps address various image defects that are often associated with multi-projection systems. The system can independently move each image component of a multiple projection system in a composite display. The input to each projector is simultaneously recalculated, based on relative position, to reduce distracting visual defects of the overlapping blended images, and allows improvement in uniformity (e.g. of color and brightness) across the complete projected image.

The system takes a group of individual projection displays, or pixel groups, and varies the position relative to each other over time in a controlled and known manner. At the same time, the data input to each display device is calculated as a function of the location of the individual displays and an established reference. The frequency and range of movement depend on the application and the steering system used. The movement can be either smooth or effectively discreet. The movement frequency could range from as high as sub-frame timing to as slow as many frames per cycle. This system can also perform a one-time operation that superimposes a position offset to the projection displays based upon the distance to the screen or other factors.

This system Improves uniformity in brightness and image quality across and entire image, helps hide seams or blended areas of pixel groups in an image, decreases the screen-door appearance, and also helps with defect masking. Indeed, this system can claim most of the advantages of wobulation systems. Additionally, depending on the pixel group movement, the displayed image can vary in aspect ratio or shape. Finally, this system also compensates for offset in projector positions to find a best solution. For example, if the initial alignment of a projector in a group is inaccurate, the dynamic superposition system can add a fixed offset to compensate. This can be an advantage over static multi-projector systems which are constrained by initial mechanical alignment.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A system for producing a composite image in a multiple projection system, comprising:
at least two projectors, each configured to project a component image at an image refresh rate;
a dynamic image shifting mechanism, associated with at least one of the at least two projectors, configured to shift a projection path of the component image of the at least one projector; and
a controller, connected to control the at least one projector and the dynamic image shifting mechanism, configured to modify image data sent to the at least one projector and to shift the dynamic image shifting mechanism to produce a single composite image comprising the component images.

2. A system in accordance with claim 1, further comprising a dynamic image shifting mechanism associated with each of the at least two projectors, configured to shift a projection path of the component image of each projector.

3. A system in accordance with claim 1, wherein the dynamic image shifting mechanism comprises a tilting mirror, disposed in the projection path, and configured to reflect the image to a projection surface.

4. A system in accordance with claim 3, wherein the tilting mirror is configured to tilt in two degrees of freedom, so as to shift the projection path in two dimensions.

5. A system in accordance with claim 1, further comprising a wobulation system, configured to shift the projection path by a dimension that is less than a size of a pixel of the image.

6. A system in accordance with claim 5, wherein the wobulation system comprises a wobulation device associated with each of the at least two projectors.

7. A system in accordance with claim 1, wherein the controller is configured to modify image data and adjust the image shifting mechanism to combine the component images to vary a shape of the composite image.

8. A system in accordance with claim 1, wherein the component images are configured to overlap with each other in the range of from 0% to 100%, and the controller is configured to modify the image data to edge-blend overlap areas of the component images.

8. A system in accordance with claim 1, wherein the controller is configured to modify image data and shift the dynamic image shifting device at a rate that is greater than an image refresh rate of the at least two projectors.

9. A system in accordance with claim 8, wherein the controller is configured to shift the image projection path by a distance that is a multiple of a fractional pixel dimension.

10. A system in accordance with claim 9, wherein the controller is further configured to resample image data to project the image with shifted pixel boundary locations.

11. A method for producing a composite image in a projection system having an image refresh rate, comprising the steps of:
projecting at least two component images to a projection surface, the component images combining to create the composite image;
shifting a position on the projection surface of at least one of the at least two component images; and
dynamically recalculating image data corresponding to the at least two component images, to (1) compensate for shifting of the position of the at least one component image while (2) retaining the composite image in a substantially constant position on the projection surface.

12. A method in accordance with claim 11, wherein the step of shifting a position of at least one of the at least two component images comprises shifting a position of each of the at least two component images.

13. A method in accordance with claim 11, wherein the steps of shifting at least one of the component images and dynamically recalculating image data comprises shifting the at least one component image and dynamically recalculating the image data at a rate that is greater than the image refresh rate of the projection system.

14. A method in accordance with claim 11, further comprising the step of wobulating at least one of the at least two component images, so as to increase the apparent resolution of the at least one component image.

15. A method in accordance with claim 14, wherein the step of wobulating the at least one component image comprises shifting the image a sub-pixel dimension using a tilting mirror.

16. A method for combining component images in a multiple projection system, comprising the steps of:
projecting at least two component images to a projection surface, the component images having an overlap region and combining to create a single composite image;
shifting a position on the projection surface of the at least two component images; and
dynamically recalculating image data corresponding to the at least two component images, so as to compensate for shifting of position of the component images.

17. A method in accordance with claim 16, wherein the step of dynamically recalculating image data comprises temporally dividing an image frame into at least two superpositon sub-frames, and recalculating image data for each superposition sub-frame, and the step of shifting the position of at least one of the at least two component images comprises shifting the position to a different position for display of each superposition sub-frame.

18. A method in accordance with claim 11, wherein the step of dynamically recalculating image data comprises recalculating an image area and a blank area of each component image, and recalculating edge-blending characteristics of the overlap region of the component images.

19. A method in accordance with claim 11, wherein the step of dynamically recalculating image data comprises recalculating image data to compensate for shifting of the component images while retaining the composite image in a substantially constant position with respect to the projection surface.

20. A method in accordance with claim 11, further comprising the step of wobulating the component images, so as to increase the apparent resolution of the composite image.
